(19) United States
(12) Patent Application Publication
(10) Pub. No.: US 2018/0301144 A1
(43) Pub. Date: Oct. 18, 2018

(54) ELECTRONIC DEVICE, METHOD FOR ADAPTING ACOUSTIC MODEL THEREOF, AND VOICE RECOGNITION SYSTEM

(71) Applicant: Samsung Electronics Co., Ltd., Suwon-si, Gyeonggi-do (KR)

(72) Inventors: Kyung-mi PARK, Suwon-si (KR); Sung-hwan SHIN, Yongin-si (KR)

(73) Assignee: Samsung Electronics Co., Ltd., Suwon-si, Gyeonggi-do (KR)

(21) Appl. No.: 15/765,842

(22) PCT Filed: Oct. 21, 2016
(86) PCT No.: PCT/KR2016/011885

§ 371 Date: Apr. 4, 2018

(30) Foreign Application Priority Data
Oct. 21, 2015 (KR) 10-2015-0146417

(51) Int. Cl. G10L 15/07; G10L 15/06; G10L 15/22

(52) U.S. Cl. CPC G10L 15/07; G10L 2015/0635; G10L 15/22; G10L 15/063

(57) ABSTRACT

An electronic device, a method for adapting an acoustic model thereof, and a voice recognition system are provided. According to one embodiment of the present invention, the electronic device comprises: a voice input unit for receiving a voice signal of a user; a storage unit for storing, therein, a transformer having a plurality of transformation parameters and an acoustic model having a parameter transformed by the transformer; and a control unit for generating a hypothesis from the received voice signal by using the acoustic model, estimating, by using the hypothesis, an optimal transformer having an optimal transformation parameter on which a voice feature of the user is reflected, and updating the plurality of transformation parameters of the transformer stored in the storage unit by combining the estimated optimal transformer with the transformer.

### TECHNICAL FIELD

The present invention relates to an electronic device, a method for adapting an acoustic model thereof, and a voice recognition system and, more particularly, to an electronic device which is capable of adapting an acoustic model to a specific user or an environment at high speed by using a small amount of user voice, an adapting acoustic model thereof, and a voice recognition system.

### BACKGROUND ART

Conventionally, when a user uses various electronic devices such as a mobile device and a display device, a user command is input using a tool such as a keyboard and a remote controller. However, amid diversification of input methods of a user command input method, there is an increasing concern regarding voice recognition.

Conventional voice recognition systems used in mobile devices and display devices show a large performance difference depending on a specific user or ambient noise. Since the acoustic model (AM) of the voice recognizer is generated based on the large-capacity voice data collected from the multi-speaker, it is difficult to provide high-performance voice recognition for a specific speaker or environment. Accordingly, a personalization service that adapts a conventional speaker-independent acoustic model to a speaker-dependent acoustic model based on an actual user sound source, and provides an acoustic model optimized for each user.

However, the conventional acoustic model adaptation method has a compulsion in the registration process in which a user must read a predetermined word or sentence. In addition, in order to ensure the improvement of the voice recognition performance, approximately 30 seconds to 2 minutes of user voice was required. As the recent report that the users who use the voice recognition service have a very high defection rate, there is a need to adapt the acoustic model with only a small amount of actual user data because the reuse rate of the user is low if immediate performance improvement is not felt. Therefore, the conventional acoustic model adaptation method for compulsorily inputting a large amount of data has a problem in that it cannot prevent the defection of a user.

There is a problem that it is difficult to find an optimized solution for the acoustic model parameter estimation even when a very small amount of actual user data is used. When using an inappropriate adaptive algorithm, over-fitting improves adaptability to certain parameters, resulting in overall performance degradation.

In order to reduce the problem, an adaptation method based on linear-regression transform is widely used, but an adaptation method having a performance which enables application to a product has not been developed yet.

### DETAILED DESCRIPTION

### Technical Tasks

The present disclosure is to provide an electronic device which adapts an acoustic model at high speed based on extremely small amount of sound source of a real user so that a user may feel improvement of recognition performance on a real-time basis, a method for adapting an acoustic model, and a voice recognition system.

### Means for Solving Problems

In order to achieve the purpose of the present disclosure, the present invention obtains an unsupervised user utterance and uses it for hypothesis generation, estimates an optimal transformer using a structural regularized minimum classification error linear regression (SR-MCELR) algorithm, and incrementally connects the estimated transformer to a next step. Thus, the present invention can prevent the overfitting and improve the perceived recognition rate in real time.

An electronic device according to an exemplary embodiment includes a voice input unit configured to receive a voice signal of a user; a storage unit configured to store a transformer having a plurality of transformation parameters and an acoustic model having a parameter transformed by the transformer; and a control unit configured to generate a hypothesis from the received voice signal by using the acoustic model, and estimate, by using the hypothesis an optimal transformer having the optimal transformation parameter to which a voice characteristic of the user is reflected, wherein the control unit may update the plurality of transformation parameters of the transformer stored in the storage by combining the estimated optimal transformer and the transformer.

The control unit, in response to the voice input of the user being an initial input, may estimate the optimal transformer using a global transformer and the generated hypothesis.

The control unit, in response to a previous voice input of the user existing, may estimate an optical transformer regarding a current voice input using an optimal transformer of the previous voice input and the generated hypothesis.

The control unit may generate a plurality of hypothesis regarding the received voice signal, sets a hypothesis having highest matching ratio of the voice signal from among the plurality of hypothesis as a reference hypothesis and set remaining hypothesis as a competitive hypothesis.

The control unit may increase a transformation parameter corresponding to the reference hypothesis from among the transformation parameter of the optimal transformer regarding the previous voice input, reduce a transformation parameter corresponding to the competitive hypothesis, and estimate an optimal transformation parameter regarding the current voice input.

The control unit may measure reliability of the generated hypothesis and determine a combination ratio of the transformer and the optimal transformer based on the measured reliability.

The control unit may generate a hypothesis using free utterance of the user.

The transformation parameter of the transformer may be updated by phonemes of the received voice signal of the user.

According to an exemplary embodiment, a method of adaptation of an acoustic model of an electronic device is disclosed. The method includes receiving a voice signal of a user; generating a hypothesis from the received voice signal by using an acoustic model in which a parameter is transformed by a transformer having a plurality of transformation parameters; estimating, by using the hypothesis, an optimal transformer having the optimal transformation parameter to which a voice characteristic of the user is reflected; and updating the plurality of transformation parameters of the transformer stored in the storage by combining the estimated optimal transformer and the transformer.

The estimating may include, in response to the voice input of the user being an initial input, estimating the optimal transformer using a global transformer and the generated hypothesis.

The estimating may include, in response to a previous voice input of the user existing, estimating an optical transformer regarding a current voice input using an optimal transformer of the previous voice input and the generated hypothesis.

The generating may include generating a plurality of hypothesis regarding the received voice signal and setting a hypothesis having highest matching ratio of the voice signal from among the plurality of hypothesis as a reference hypothesis and setting remaining hypothesis as a competitive hypothesis.

The estimating may include increasing a transformation parameter corresponding to the reference hypothesis from among the transformation parameter of the optimal transformer regarding the previous voice input, reducing a transformation parameter corresponding to the competitive hypothesis, and estimating an optimal transformation parameter regarding the current voice input.

The updating may include measuring reliability of the generated hypothesis and determining a combination ratio of the transformer and the optimal transformer based on the measured reliability.

The generating may include generating a hypothesis using a free utterance of the user.

The transformation parameter of the transformer may be updated for each phoneme of the received voice signal of the user.

A voice recognition system according to another exemplary embodiment includes a cloud server for storing an acoustic model and an electronic device which receives a voice signal of the user, generates a hypothesis by using the received voice signal, estimates a transformer in which a voice characteristic of the user is reflected, and transmits the estimated transformer to the cloud server, and the cloud server may recognize a voice of the user using the stored acoustic model and the received transformer and transmit the recognized result to the electronic device.

### Effect of Invention

According to various embodiments of the present invention as described above, the acoustic model is adapted to acoustic characteristics of a user and a user environment at a high speed using only a small amount of real user data, thereby maximizing voice recognition performance and usability. In addition, it is possible to prevent the user from departing the voice recognition service using the electronic device with rapid optimization and to continuously induce the reuse of the voice recognition function.

### BRIEF DESCRIPTION OF DRAWINGS

FIG. 1 is a brief block diagram for illustrating a configuration of an electronic device according to an exemplary embodiment,

FIG. 2 is a detailed block diagram for illustrating a configuration of an electronic device according to an exemplary embodiment,

FIGS. 3 and 4 are concept diagrams to describe a function of an electronic device according to an exemplary embodiment,

FIG. 5 is a drawing for describing generating a hypothesis using FST-based lattice in an electronic device according to an exemplary embodiment,

FIG. 6 is a drawing for describing selection of a transformer in an electronic device according to an exemplary embodiment,

FIG. 7 is a drawing for describing incremental adaptation of an acoustic model according to a voice input in an electronic device according to an exemplary embodiment,

FIG. 8 is a concept diagram illustrating a voice recognition system according to an exemplary embodiment,

FIGS. 9 and 10 are flowcharts to describe an acoustic model adaptation method of an electronic device according to various exemplary embodiments, and

FIG. 11 is a sequence map to describe an operation of a voice recognition system according to an exemplary embodiment.

### BEST MODE

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments may be practiced without those specifically defined matters. Also, well-known functions or constructions are not described in detail since they would obscure the description with unnecessary detail.

The terms such as “first,” “second,” and so on may be used to describe a variety of elements, but the elements should not be limited by these terms. The terms are used only for the purpose of distinguishing one element from another. A singular expression includes a plural expression, unless otherwise specified. It is to be understood that the terms such as “comprise” or “consist of” are used herein to designate a presence of characteristic, number, step, operation, element, component, or a combination thereof, and not to preclude a presence or a possibility of adding one or more of other characteristics, numbers, steps, operations, elements, components or a combination thereof.

The terms used herein are used to illustrate the embodiments and are not intended to limit the invention. The singular forms “a,” “an,” and “the” include plural referents unless the context clearly dictates otherwise. In the present application, the term “comprise” or “comprising”, etc. is intended to specify that there are stated features, numbers, operations, acts, elements, parts or combinations thereof, but do not preclude the presence or addition of an element, an operation, a component or combination thereof.

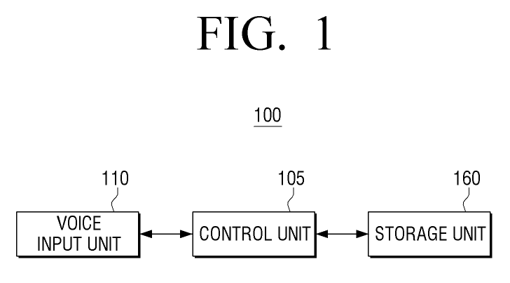

FIG. 1 is a brief block diagram for illustrating a configuration of an electronic device according to an exemplary embodiment. Referring to FIG. 1, an electronic device 100 may include a voice input unit 110, a storage unit 160, and a control unit 105.

The electronic device 100 according to an exemplary embodiment may be implemented as all the electronic devices which are capable of voice recognition such as a display device as a smart TV, a tablet PC, an audio device, and navigation.

The voice input unit 110 may receive a voice signal of a user. For example, the voice input unit 110 may be implemented as a microphone to receive a voice signal of a user. The voice input unit 110 may be embedded inside the electronic device 100 to be integrally formed or separately formed.

The storage unit 160 may include a transformer used in the control unit 105, an acoustic model (AM), a language model (LM) and so on.

The control unit 105 may generate a hypothesis from the received voice signal using the acoustic model. Then, the control unit 105 can estimate the optimal transformation parameter reflecting the voice characteristic of the user using the generated hypothesis. A transformer with an optimal transformation parameter is called an optimal transformer.

The control unit may update a plurality of transformation parameters of a transformer stored in the storage unit 160 by combining an optimal transformer estimated and a transformer used to convert an acoustic model parameter at the present voice recognition stage.

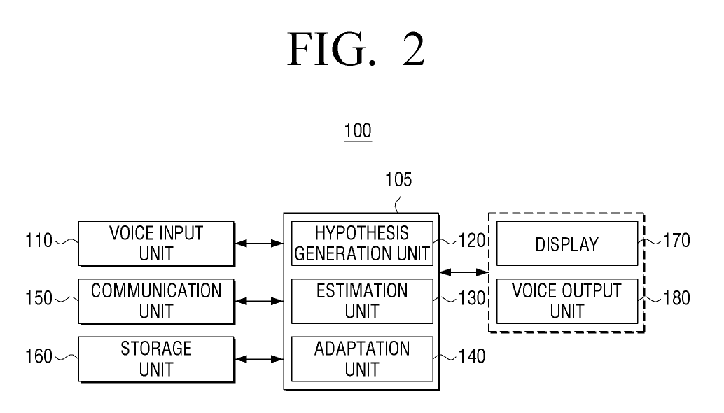

The control unit 105 may perform various operations by using the program and data stored in the storage unit 160 or the internal memory. According to an exemplary embodiment of FIG. 2, the control unit 105 may include functional modules such as a hypothesis generation unit 120, an estimation unit 130, and an adaptation unit 140. Each function module may be implemented in the form of a program stored in the storage unit 160 or an internal memory, or may be implemented as a separate hardware module.

When implemented in the form of a program, the control unit 105 may include a memory such as RAM or ROM and a processor that executes each functional module stored in such memory and performs operations such as hypothesis generation, parameter estimation, and transformer update.

Hereinbelow, the operations of the control unit 105 are described as operations of the hypothesis generation unit 120, the estimation unit 130, and the adaptation unit 140. However, it is not limited to each function module and operation.

The hypothesis generation unit 120 may generate hypotheses from the voice signal of the received user. For example, the hypothesis generation unit 120 may generate a hypothesis by decoding each user's utterance. The hypothesis generation unit 120 according to an embodiment of the present invention may use an unsupervised adaptation method that generates a hypothesis using a free speech of a user instead of a registered adaptive supervised adaptation method of forcing a user to utter a specific sentence.

For example, the hypothesis generation unit 120 may decode a user's free voice signal into a weighted finite state transformer (WFST)-based lattice. In addition, the hypothesis generation unit 120 may generate a plurality of hypotheses by using a WFST-based grid. The hypothesis generation unit 120 may set the hypothesis to be the most probable path among the plurality of hypotheses generated, or to follow the one-best path. Then, the hypothesis generation unit 120 may set the remaining hypotheses as a competitive hypothesis and use the hypotheses for future optimal transformer estimation.

Transformers are used to transformation parameters within an acoustic model (AM). The acoustic model consists of tens of thousands to tens of millions of parameters. In adapting an acoustic model to a specific speaker or a specific environment, it is not efficient to directly change all of these large numbers of parameters. Therefore, the electronic device 100 can adapt the acoustic model with only a small amount of calculation using the transformer.

For example, a transformer can do clustering acoustic models from as few as 16 to as many as 1024 (or more). The transformer has change parameters inside as many as the clustered number. That is, the transformer can adapt the acoustic model by transforming several thousand transformation parameters, instead of directly changing tens of millions of parameters.

According to one embodiment of the present invention, the electronic device 100 may estimate an optimal transformation parameter of the transformer using the SR-MCELR algorithm. The transformer with the estimated optimal transformation parameters can be defined as the optimal transformer.

The estimation unit 130 may estimate an optimal transformation parameter of an optimal transformer that reflects a user's acoustic characteristic using the generated hypothesis. The electronic device 100 according to an exemplary embodiment of the present invention uses only a very small amount of user voice signal for about 10 seconds, which may cause an overfitting problem. In order to solve this problem, the estimation unit 130 may use the optimal transformer of the previous stage as a regularizer.

For example, if a user's previous voice input is present, the estimation unit 130 may estimate an optimal transformation parameter of the optimal transformer for the current voice input, using the optimal transformer for the previous voice input and the generated hypothesis. Through this process, the estimation unit 130 can propagate the information of the current optimal transformer to the next voice recognition step incrementally.

As another example, if the user's voice is input for the first time, the estimation unit 130 may use the global transformer to determine the optimal transformer for the user's first voice input, since the optimal transformer for the previous voice input is not estimated. The optimal transformation parameter can be estimated. The global transformer is a transformer that is estimated for several speakers (for example, thousands to tens of thousands) at the development stage. Without the global transformer, there may be a performance decline because there is no pivot used to transform the acoustic model parameters. For this reason, the estimation unit 130 may use a global transformer corresponding to an average value for a plurality of speakers for the initial voice input. The global transformer may be stored in the manufacturing stage of the electronic device 100 or may be received from an external device such as the cloud server 200 having a large capacity acoustic model.

The estimation unit 130 according to an embodiment of the present invention may use a tree structure-based linear transformation adaptive algorithm. For example, the estimation unit 130 may use a Structured Regularized Minimum Classification Error Linear Regression (SR-MCELR) algorithm. The SR-MCELR algorithm is superior to the existing adaptive algorithms (MLLR, MAPLR, MCELR, SMAPLR, for example) for voice recognition accuracy.

The SR-MCELR algorithm was developed to be used in the registration adaptation scheme, and was used in a static prior method without considering incremental adaptation scenarios. However, the electronic device 100 according to an embodiment of the present invention improves the SR-MCELR algorithm so that it can be used in an unregistered adaptation scheme, and enables incremental adaptation. That is, in the electronic device 100 according to an embodiment of the present invention, a dynamic prior method is used.

The estimation unit 130 may increase the transformation parameter corresponding to the reference hypothesis among the transformation parameters of the selected transformer (for example, the general transformer or the optimal transformer for the previous voice input) according to whether the user is the initial voice input. Further, the estimation unit 130 may reduce the transformation parameter corresponding to the competitive hypothesis among the transform parameters of the selected transformer.

The adaptation unit 140 may propagate the optimal transformer and the sound source estimated in the current adaptation step to the next adaptation step in an incremental manner. For example, the adaptation unit 140 may update the transformer by combining the currently used transformer with the estimated best transformer using the current voice input, and creating the transformer to be used in the next voice recognition step. The adaptation unit 140 may adjust the adaptive balance by adding a weight in the process of propagating to the next adaptation step. For example, the adaptation unit 140 may measure the reliability of the hypothesis and determine the combination ratio of the currently used transformer and the estimated optimal transformer using the current voice input, based on the measured reliability. Through this process, the adaptation unit 140 can prevent overfitting.

Through the electronic device 100 according to various exemplary embodiments as described above, even if an excessively small amount of data of real users is used, voice recognition optimized to acoustic characteristics of a user at high speed is available.

FIG. 2 is a block diagram for describing the configuration of the electronic device 100 according to an embodiment of the present invention in detail. Referring to FIG. 2, the electronic device 100X) may include a voice input unit 110, a control unit 105, a communication unit 150, a storage unit 160, a display unit 170, and a voice output unit 180. The control unit 105 may include a hypothesis generation unit 120, an estimation unit 130, and an adaptation unit 140.

The voice input unit 110 may receive the voice signal of the user. For example, the voice input unit 110 may be implemented as a microphone to receive a user's voice signal. The voice input unit 110 may be integrated in the electronic device 100 or may be implemented in a separate form.

In addition, the voice input unit 110 may process received voice signal of a user. For example, the voice input unit 110 may remove noise from user's voice.

Specifically, the voice input unit 110 can sample a user's voice in analog form and transform it into a digital signal. The voice input unit 110 may calculate the energy of the transformed digital signal and determine whether the energy of the digital signal is equal to or greater than a predetermined value.

When the energy of the digital signal is equal to or greater than a predetermined value, the voice input unit 110 removes the noise component from the digital signal and transmits the result to the hypothesis generation unit 120 and the estimation unit 130. For example, the noise component may be sudden noise that may occur in a home environment, such as an air conditioner sound, a cleaner sound, or a music sound. In the meantime, when the energy of the digital signal is less than a predetermined value, the voice input unit 110 waits for another input without performing any process on the digital signal. As a result, the entire audio processing process is not activated by a sound other than the user's uttered voice, thereby preventing unnecessary power consumption.

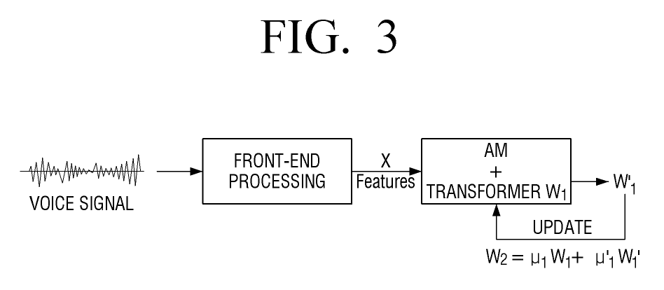

The hypothesis generation unit 120, the estimation unit 130, and the adaptation unit 140 will be described below with reference to FIGS. 3 to 7.

The communication unit 150 performs communication with an external device such as a cloud server 200. For example, the communication unit 150 may transmit a voice signal and a transformer to the cloud server 200 and receive response information from the cloud server 200.

For this, the communication unit 150 may include various communication modules such as a short-range wireless communication module (not shown), a wireless communication module (not shown), and the like. Here, the short-range wireless communication module is a module for performing communication with an external device located at a short distance according to a short-range wireless communication method such as Bluetooth, ZigBee method or the like. The wireless communication module is a module that is connected to an external network and performs communication according to a wireless communication protocol such as WiFi. IEEE, or the like. In addition, the wireless communication module may further include a mobile communication module which access to a mobile communication network and performs communication according to various mobile communication standards such as 3rd Generation (3G), 3rd Generation Partnership Project (3GPP), Long Term Evolution (LTE).

The storage unit 160 may include an acoustic model (AM), a language model (LM), and the like used in the hypothesis generation unit 120 and the like. The storage unit 160 is a storage medium storing various programs and the like necessary for operating the electronic device 100, and may be implemented as a memory, a hard disk drive (HDD), or the like. For example, the storage unit 160 may include a ROM for storing a program for performing an operation of the electronic device 100, a RAM for temporarily storing data according to the operation of the electronic device 100, and the like have. In addition, it may further include an Electrically Erasable and Programmable ROM (EEROM) for storing various reference data.

As another example, the storage unit 160 may prestore various response messages corresponding to the user's voice as voice or text data. The electronic device 100 reads out at least one of voice and text data corresponding to the received user voice (in particular, a user control command) from the storage unit 160 and outputs it to the display unit 170 or the voice output unit 180.

According to another exemplary embodiment, the electronic device 100 may include the display unit 170 or the voice output unit 180 as an output unit to provide dialog-format voice recognition function.

The display unit 170 is implemented by a liquid crystal display (LCD), an organic light emitting diode (OLED) or a plasma display panel (PDP). It is possible to provide a variety of display screens that can be provided through the Internet. In particular, the display unit 170 may display a response message corresponding to the user's voice as text or image.

The audio output unit 180 may be implemented as an output port such as a jack or a speaker and output a response message corresponding to a user voice as a voice.

The hypothesis generation unit 120 may generate a hypothesis on a phoneme basis for each user utterance. The generated hypothesis is used in the subsequent adaptation process. The quality of the hypotheses used in the adaptation process is very important information that determines the final adaptation performance.

The estimation unit 130 uses an optimal transformer of the previous adaptation step for incremental adaptation. If the user's utterance is input for the first time (for example, when power is applied to the electronic device 100 for the first time, in the case of user addition registration), the estimation unit 130 may use the global transformer instead. For example, the estimation unit 130 may determine whether the user's voice input was first performed, and may then select a transformer to use for the optimal transformer estimation in the current voice input. The estimation unit 130 may use the selected transformer as prior information.

Also, the estimation unit 130 may estimate the optimal transformer while avoiding overfitting by using the preceding information and the tree structure algorithm. For example, the estimation unit 130 may estimate the adaptive parameter by comparing the feature parameter extracted through free speech with a preset reference parameter.

The adaptation unit 140 performs a function of incrementally connecting the optimal transformers of the current adaptation step and the adaptive speech to the next adaptation step. For example, the adaptation unit 140 may adjust the adaptation rate by calculating the propagation weight.

Hereinbelow, the operations of the hypothesis generation unit 120, the estimation unit 130, and the adaptation unit 140 will be further described with reference to FIGS. 3-7.

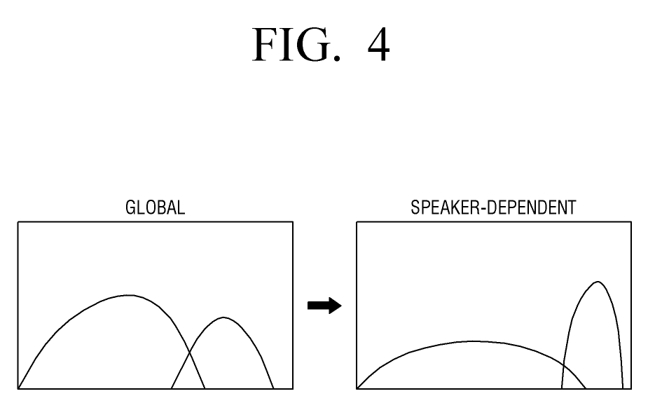

FIGS. 3 and 4 are concept diagrams to describe a function of an electronic device according to an exemplary embodiment.

Referring to FIG. 3, the acoustic model adaptation process of one cycle of the electronic device 100 according to an exemplary embodiment will be described in brief.

First, the voice input unit 110 receives a voice signal of a specific user. The voice input unit 110 can perform a front-end (FE) process to extract the voice signal X. For example, X may be a single phoneme.

Thereafter, the hypothesis generating unit 120 may generate a hypothesis using the acoustic model AM and the transformer W1. Specifically, the hypothesis generation unit 120 can generate a hypothesis using the acoustic model whose parameters have been transformed by the transformation parameters of the transformer W1. If the voice input of the user is made for the first time, the transformer W1 selected by the estimation unit 130 may be a global transformer. Conversely, if voice input of the previous user exists, the transformer W1 selected by the estimation unit 130 may be an optimal transformer estimated from the previous voice signal. The electronic device 100 can prevent the overfitting by using the thus selected transformer W1 as a regularizer.

The estimation unit 130 may estimate the optimal transformation parameter of the optimal transformer W1 in the current speech input by using the selected transformer W1 and the generated hypothesis.

The adaptation unit 140 may update the transformer incrementally by giving the weights μ1 and μ1′ to the transformer W1 of the previous stage and the optimal transformer W1′ estimated for the current voice input, respectively (W1->W2).

Next, when the voice of the user is input again, the electronic device 100 performs voice recognition using the acoustic model and the updated transformer W2.

Through the acoustic model adaptation process as described above, as shown in FIG. 4, the electronic device 100 can adapt the global acoustic model to the speaker-dependent acoustic model. As a result, it is possible to reflect the pronunciation habits and characteristics of each user, thereby solving the problem that the recognition rate differs for each user.

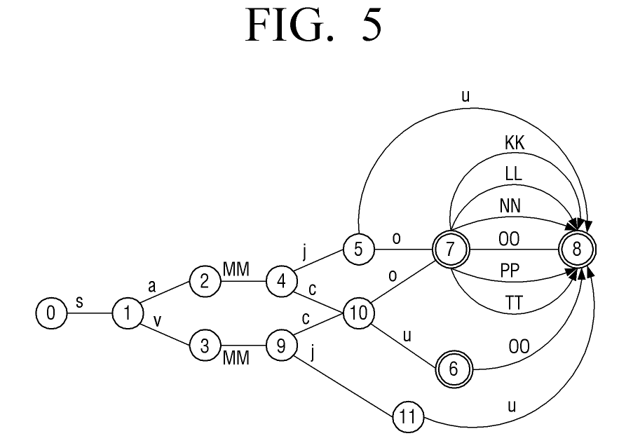

FIG. 5 is a diagram for describing that the electronic device 100 generates a hypothesis by using a WFST-based lattice according to an embodiment of the present invention. The WFST-based voice recognition decoder finds the path with the highest weight-based probability from the integrated transducer and obtains the final recognized word sequence from this path. For example, each FST that is the prototype of the lattice can be composed of phonemes. Thus, a phoneme-based lattice can be used in the adaptation process that generates hypotheses.

Composition, determination, and minimization algorithms can be applied to obtain an integrated transducer. FIG. 5 is an example showing an integrated transducer. The hypothesis generation unit 120 may generate a plurality of hypotheses from the paths of the integrated transducers. The hypothesis generation unit 120 may set the hypothesis having the highest probability among the plurality of hypotheses as the reference hypothesis. The hypothesis generation unit 120 may set the hypothesis to the competitive hypothesis instead of discarding the remaining hypotheses, and may be use the hypotheses for the subsequent adaptation process.

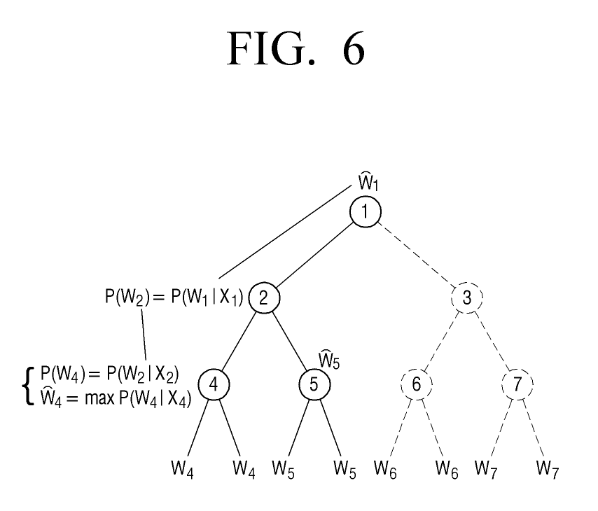

FIG. 6 is a diagram for describing a transformer selection in the electronic device 100 according to an embodiment of the present invention. For example, the estimation unit 130 may select a previous stage transformer to use as prior information using the tree-structured SR-MCELR algorithm. Transformers measured at a particular node may provide useful information that constrains the measurement of their child nodes. For example, the posterior distribution of a parent node may be used as a prior distribution of child nodes. Taking FIG. 6 as an example, the posterior distribution P (W1|X1) of the node \textcircled{1} corresponds to the pre-distribution P (W2) of the node \textcircled{2}. Similarly, the pre-distribution P (W4) of the node \textcircled{4} corresponds to the posterior distribution P (W2|X2) of the node \textcircled{2}.

The estimation unit 130 may determine whether to propagate a prior transformer by comparing a predetermined threshold and a posterior probability value of each adaptation data. For example, in the case of the nodes \textcircled{1}, \textcircled{2}, \textcircled{4} and \textcircled{5} in which the posterior probability value is determined to be greater than the predetermined threshold value, the estimation unit 130 can use the preceding transformer as a regularizer by propagating the preceding transformer. Conversely, in the case of the node \textcircled{6}, the estimation unit 130 uses W1 of the node \textcircled{1} as a preceding transformer.

Meanwhile, the estimation unit 130 may estimate a parameter value of the transformer by using a minimum classification error (MCE) algorithm at each node. The estimation unit 130 can estimate the optimal transformation parameter of the optimal transformer for the current voice input by increasing the transformation parameter corresponding to the reference hypothesis among the transformation parameters of the preceding transformer and decreasing the transformation parameter corresponding to the competitive hypothesis. That is, the reference hypothesis and the competitive hypothesis generated by the hypothesis generation unit 120 are input to the MCE optimization process and used to estimate the transformation parameters in a direction to enhance the discrimination.

The adaptation unit 140 may propagate the optimal transformer and the sound source estimated in the current adaptation step to the next adaptation step incrementally. Also, the adaptation unit 140 may adjust the balance of the acoustic model adaptation process by adding a weight when propagating to the next adaptation step. That is, the adaptation unit 140 plays a role of determining how much the current-stage solution will affect the next-stage solution.

The adaptation unit 140 can measure the reliability of the generated hypothesis through the propagation weight threshold. Then, the adaptation unit 140 can add a propagation weight based on the measured reliability to determine the combination ratio of the preceding transformer and the estimated optimal transformer.

For example, the adaptation unit 140 can measure the reliability by combining the scores of the following three schemes. First, the difference between the target model score and the background model score can be obtained for each phoneme of the recognition result. Second, posterior probabilities for each phoneme can be measured in the WFST grid. Third, the lattice used for recognition can be converted into a confusion network to give phoneme chaos scores. These three measured scores can be combined and normalized to finally measure the confidence value between 0 and 1 per phoneme. The larger the confidence value, the more consistent the utterance and phoneme of a particular user, and the lower the confidence value, the greater the difference between a particular user's utterance and phoneme.

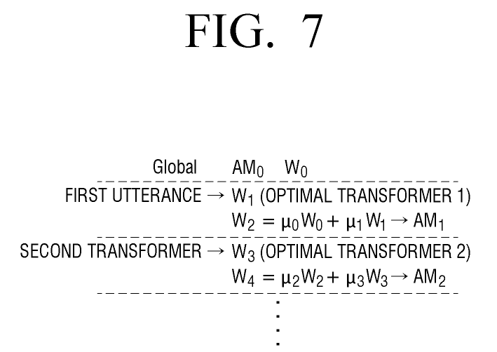

FIG. 7 is a diagram for describing that an acoustic model is incrementally adapted according to a user's voice input in the electronic device 100 according to an embodiment of the present invention. FIG. 7 shows only the first utterance and the second utterance of the user.

It can be seen that before the initial utterance of the user, the acoustic model AM0 and the global transformer W0, previously stored in the manufacturing stage, exist. When the user's first utterance is input, the electronic device 100 can estimate the optimal transformation parameter of the optimal transformer W1 from the current utterance of the user. Then, the weights (μ0, μ1) can be determined and the transformer W2 to be used in the next adaptation step can be determined. Then, the electronic device 100 can update the parameters of the acoustic model through the determined transformer W2 (AM0→AM1).

When the second utterance of the user is input, the electronic device 100 can perform the adaptation process by using the acoustic model AM1 incrementally adapted in the previous step and the optimal transformer W2 in the previous stage. Similarly, it is possible to estimate the optimal transformation parameter of the optimal transformer W3 from the current speech (second speech) of the user. Then, the weights (μ2, μ3) can be determined and the transformer W4 to be used in the next adaptation step can be determined. Then, the electronic device 100 can update the parameters of the acoustic model through the determined transformer W4 (AM1→AM2).

The acoustic model can be adapted to the acoustic characteristics of the user and the user environment at a high speed by utilizing only a very small amount of actual user data through the electronic device 100 according to various embodiments as described above. As a result, voice recognition performance and usability are maximized. In addition, it is possible to prevent the user from using the voice recognition service using the electronic device with rapid optimization and to continuously induce the reuse of the voice recognition function.

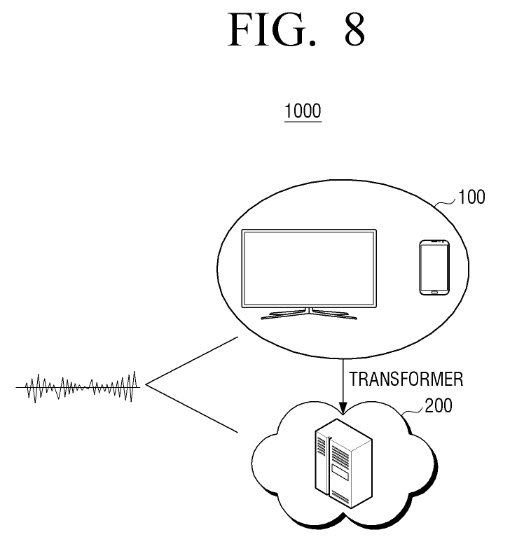

FIG. 8 is a conceptual diagram illustrating a voice recognition system 1000 according to an embodiment of the present invention. Referring to FIG. 8, the voice recognition system 1000 may include the electronic device 100 and a cloud server 200, which may be implemented as a display device, a mobile device, or the like.

The voice recognition system 1000 according to the embodiment of the present invention generates a small capacity (for example, 100 kB or less) transformer instead of directly changing the acoustic model to use a method of optimizing the acoustic model for each user.

For example, the voice recognition system 1000 may include the electronic device 100 that includes an embedded voice recognition engine, which is used to recognize a small amount of vocabulary, and a configuration for generating and updating a user's best transformer. The voice recognition system 1000 may also include a cloud server 200 that includes a server voice recognition engine that is used to recognize large amounts of vocabulary.

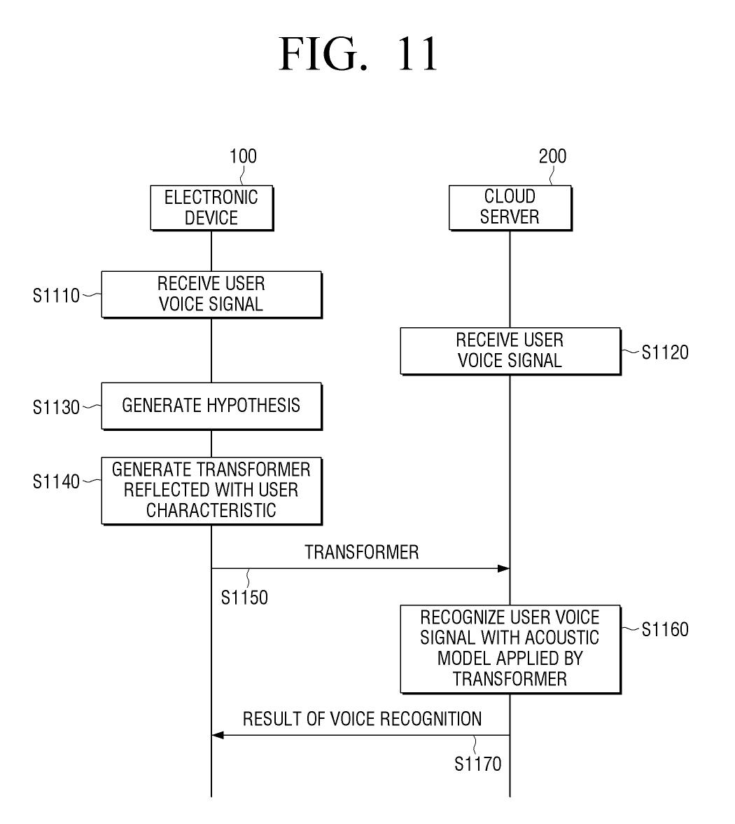

In the voice recognition system 1000 according to an embodiment of the present invention, a transformer that reflects the voice characteristics of the user input from the electronic device 100 is generated and transmitted to the cloud server 200, and the cloud server 200 may perform voice recognition using a large-capacity acoustic model (AM), a language model (LM). etc. stored in the received transformer. Accordingly, the voice recognition system 1000 can take advantage of merely using the electronic device 100 and the cloud server 200, respectively. Specific operations of the voice recognition system 1000 will be described below with reference to FIG. 11.

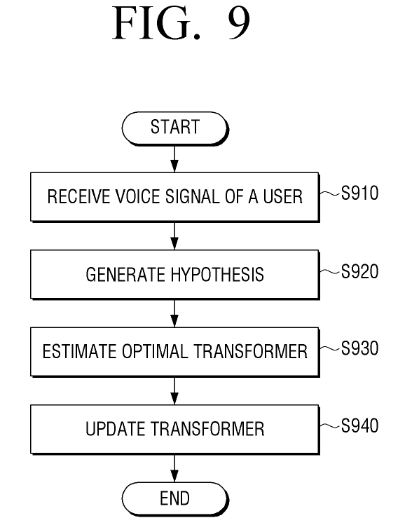

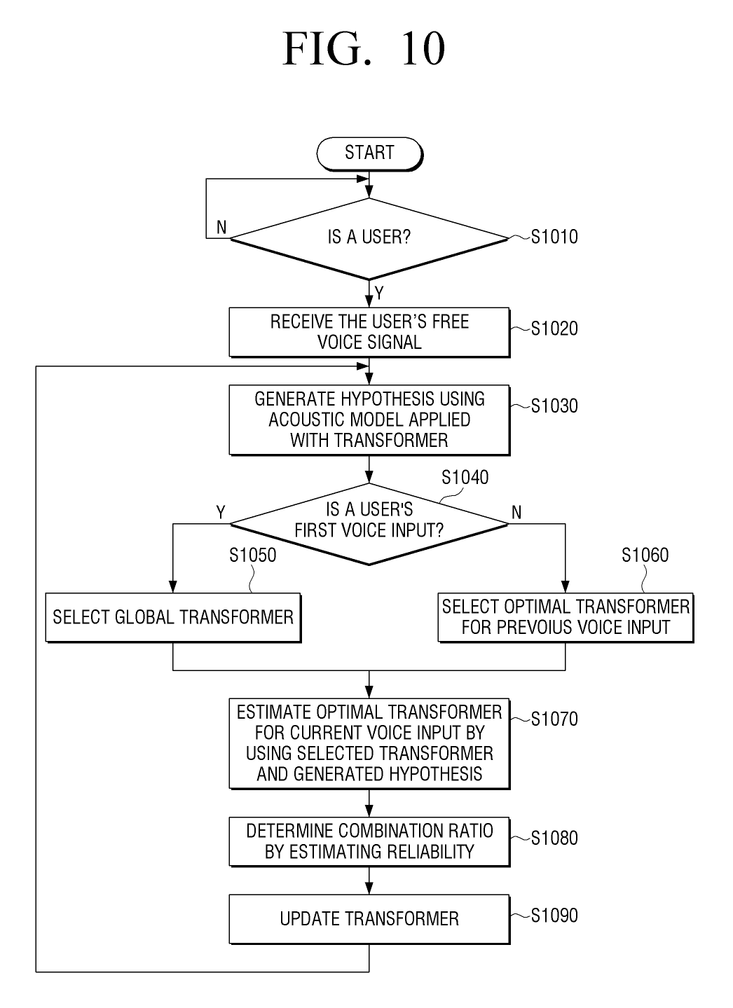

Hereinbelow, with reference to FIGS. 9 and 10, an acoustic model adaptation method of the electronic device 100 will be described according to various exemplary embodiments.

FIG. 9 is a flowchart for explaining an acoustic model adaptation method of the electronic device 100 according to an embodiment of the present invention. First, the electronic device 100 receives the user's voice signal (S910). The electronic device 100 can adapt the acoustic model by an unsupervised adaptation scheme using the free speech of the user without using a method of reading and registering a predetermined word or sentence.

Then, the electronic device 100 generates a hypothesis from the received voice signal using the acoustic model whose parameters are transformed by the transformation parameter of the transformer (S920). For example, the electronic device 100 may generate a reference hypothesis from the most probable path on a WFST grid basis. In addition, the electronic device 100 may generate a path other than the reference hypothesis as a competitive hypothesis and use it for a subsequent adaptation process.

Next, the electronic device 100 can estimate the optimal transformation parameter of the optimal transformer that reflects the user's voice characteristics using the preceding transformer and the generated hypothesis (S930). By using the preceding transformer of the previous step, the electronic device 100 can overcome the concern of overfitting at the time of the transformation parameter estimation.

Then, the electronic device 100 can update the transformation parameters of the transformer by combining the two transformers in such a manner that a weight is added to the preceding transformer and the optimal transformer estimated for the current voice input (S940).

FIG. 10 is a flowchart for describing an acoustic model adaptation method of the electronic device 100 according to another embodiment of the present invention. First, the electronic device 100 determines whether the user is recognized (S1010). For example, the case where the electronic device 100 is operated for the first time or the case where the user additionally registers is recognized may be applicable.

If the user is recognized (S1010-Y), the electronic device 100 receives the user's free voice signal (S1020). That is, the acoustic model adaptation method of the electronic device 100 according to the embodiment of the present invention does not go through the forced registration step.

Then, the electronic device 100 can generate a hypothesis using the acoustic model whose parameters are converted by the transformation parameters of the transformer (S1030). For example, the electronic device 100 may generate a plurality of hypotheses corresponding to the received voice signal. Then, the electronic device 100 can set the hypothesis having the highest probability among the plurality of generated hypotheses as the reference hypothesis. In addition, the electronic device 100 can set the competition hypothesis without discarding the remaining hypotheses, and this hypothesis can be used in the subsequent process.

The electronic device 100 determines whether the user's voice input has been made for the first time (S1040). For example, a case where the user is additionally registered and firstly uttered may correspond to a case where the user's voice input is made for the first time. If the voice input of the user is made for the first time (S1040—Y), the electronic device 100 can select the global transformer as a regularizer because there is no prior information to be referred to by the user (S1050). Conversely, if there is a previous voice input of the user (S040—N), the electronic device 100 may select an optimal transformer for the previous voice input (S1060).

Next, the electronic device 100 may estimate the optimal transformation parameter of the optimal transformer for the current voice input, by using the selected transformer and generated hypotheses (S1070). For example, the electronic device 100 may increase the transformation parameter corresponding to the reference hypothesis among the transformation parameters of the optimal transformer for the previous voice input, and reduce the transformation parameter corresponding to the competitive hypothesis. It is also possible to estimate the optimal transformation parameter of the optimal transformer.

After estimating the optimal transformer, the electronic device 100 may determine the combination ratio of the prior transformer and the estimated optimal transformer by measuring the reliability (S1080). By applying the propagation weight, the electronic device 100 can improve the convergence quality of the optimization algorithm and mitigate the over-fitting problem of the model.

The electronic device 100) may update the transformation parameters of the transformer through such a process (S1090). The electronic device 100 may use the updated transformer for analyzing a voice signal of a next user and the sound model be adapted to a specific user in an incremental manner.

FIG. 11 is a sequence map to describe an operation of a voice recognition system according to an exemplary embodiment.

The electronic device 100 and the cloud server 200 may respectively receive the user's voice signal (S1110, S1120). As another example, the electronic device 100 may receive the user's voice signal and transmit it to the cloud server 200.

The electronic device 100 generates a hypothesis using the voice of the user (S1130), and may generate a transformer reflecting the characteristics of the user (S1140). That is, the electronic device 100 may generate a transformer that reflects the acoustic characteristics of the user for each user, and may update the transformation parameters of the transformer. The electronic device 100 may transmit the generated transformer to the cloud server 200 (S1150).

The cloud server 200 may store a large-capacity acoustic model. The cloud server 200 can recognize the user's voice by using the stored acoustic model and the received transformer (S1160). Since the cloud server 200 can have a large-capacity voice recognition engine and the processing capability is superior to that of the electronic device 100, it is advantageous that the voice recognition function is performed by the cloud server 200.

The cloud server 200 may transmit a voice recognition result to the electronic device 100 to perform an operation corresponding to a user's voice input (S1170).

The above-described methods may be implemented in the form of program commands that can be executed through various computer means and recorded in a computer-readable medium. The computer-readable medium may include program instructions, data files, data structures, and the like, alone or in combination. The program commands recorded on the medium may be those specially designed and constructed for the present invention or may be available to those skilled in the art of computer software. Examples of computer-readable media include magnetic media such as hard disks, floppy disks, and magnetic tape; optical media such as CD-ROMs and DVDs; magnetic media such as floppy disks; hardware devices that are specially configured to store and execute magneto-optical media and program instructions such as ROM, RAM, flash memory, and the like. Examples of program commands include machine language code such as those produced by a compiler, as well as high-level language code that can be executed by a computer using an interpreter or the like. The above hardware devices may be configured to operate as one or more software modules to perform the operations of the present invention, and vice versa.

The foregoing example embodiments and advantages are merely examples and are not to be construed as limiting. The present teaching can be readily applied to other types of apparatuses. Also, the description of the example embodiments is intended to be illustrative, and not to limit the scope of the claims, and many alternatives, modifications, and variations will be apparent to those skilled in the art.

What is claimed is:

1. An electronic device, comprising:
a voice input unit configured to receive a voice signal of a user;
a storage unit configured to store a transformer having a plurality of transformation parameters and an acoustic model having a parameter transformed by the transformer; and
a control unit configured to generate a hypothesis from the received voice signal by using the acoustic model, and estimate, by using the hypothesis, an optimal transformer having the optimal transformation parameter to which a voice characteristic of the user is reflected,
wherein the control unit updates the plurality of transformation parameters of the transformer stored in the storage by combining the estimated optimal transformer and the transformer.

2. The electronic device of claim 1, wherein the control unit, in response to the voice input of the user being an initial input, estimates the optimal transformer using a global transformer and the generated hypothesis.

3. The electronic device of claim 1, wherein the control unit, in response to a previous voice input of the user existing, estimates an optical transformer regarding a current voice input using an optimal transformer of the previous voice input and the generated hypothesis.

4. The electronic device of claim 3, wherein the control unit generates a plurality of hypothesis regarding the received voice signal, sets a hypothesis having highest matching ratio of the voice signal from among the plurality of hypothesis as a reference hypothesis and sets remaining hypothesis as a competitive hypothesis.

5. The electronic device of claim 4, wherein the control unit increases a transformation parameter corresponding to the reference hypothesis from among the transformation parameter of the optimal transformer regarding the previous voice input, reduces a transformation parameter corresponding to the competitive hypothesis, and estimates an optimal transformation parameter regarding the current voice input.

6. The electronic device of claim 1, wherein the control unit measures reliability of the generated hypothesis and determines a combination ratio of the transformer and the optimal transformer based on the measured reliability.

7. The electronic device of claim 1, wherein the control unit generates a hypothesis using free utterance of the user.

8. The electronic device of claim 1, wherein the transformation parameter of the transformer is updated by phonemes of the received voice signal of the user.

9. A method of adaptation of an acoustic model of an electronic device, the method comprising:
receiving a voice signal of a user;
generating a hypothesis from the received voice signal by using an acoustic model in which a parameter is transformed by a transformer having a plurality of transformation parameters;
estimating, by using the hypothesis, an optimal transformer having the optimal transformation parameter to which a voice characteristic of the user is reflected; and
updating the plurality of transformation parameters of the transformer stored in the storage by combining the estimated optimal transformer and the transformer.

10. The method of claim 9, wherein the estimating comprises, in response to the voice input of the user being an initial input, estimating the optimal transformer using a global transformer and the generated hypothesis.

11. The method of claim 9, wherein the estimating comprises, in response to a previous voice input of the user existing, estimating an optical transformer regarding a current voice input using an optimal transformer of the previous voice input and the generated hypothesis.

12. The method of claim 9, wherein the generating comprises generating a plurality of hypothesis regarding the received voice signal and setting a hypothesis having highest matching ratio of the voice signal from among the plurality of hypothesis as a reference hypothesis and setting remaining hypothesis as a competitive hypothesis.

13. The method of claim 12, wherein the estimating comprises increasing a transform parameter corresponding to the reference hypothesis from among the transform parameter of the optimal transformer regarding the previous voice input, reducing a transform parameter corresponding to the competitive hypothesis, and estimating an optimal transform parameter regarding the current voice input.

14. The method of claim 9, wherein the updating comprises measuring reliability of the generated hypothesis and determining a combination ratio of the transformer and the optimal transformer based on the measured reliability.

15. The method of claim 9, wherein the generating comprises generating a hypothesis using a free utterance of the user.
